(19) United States
(12) Patent Application Publication
(10) Pub. No.: US 2010/0311387 A1
(43) Pub. Date: Dec. 9, 2010

(54) PANIC ACTIVATED LOCATOR (P.A.L.)

(75) Inventors: Melinda Marie Cameron, Playa Del Rey, CA (US); Scott David Bartholdson, Playa Del Rey, CA (US)

Correspondence Address: Melinda Cameron, 7600 W. Manchester Ave. #1223, Playa Del Rey, CA, 90293, US

(73) Assignees: Melinda Marie Cameron, Playa Del Rey, CA (US); Scott David Bartholdson, Playa Del Rey, CA (US)

(21) Appl. No.: 12/793,672

(22) Filed: Jun. 3, 2010

Related U.S. Application Data
(60) Provisional application No. 61/184,478, filed on Jun. 5, 2009.

(51) Int. Cl. H04M 11/04

(52) U.S. Cl. 455/404.2

(57) ABSTRACT

The Panic Activated Locator (P.A.L.) is a device that combines mobile phone technology and GPS tracking technology into a single unit creating a system that simultaneously notifies emergency services and triggers real-time locating capabilities with the push of a button. The P.A.L. is unique in that it allows for several important aspects of information to be conveyed not only simultaneously but also easily and reliably. With the push of a button the user/wearer can convey who they are, where they are, and that there is an emergency, without dialing, speaking, or giving directions, thus reducing response time and increasing efficiency. With the advent of the P.A.L. system a proactive approach to crime reduction is taken a step further than conventional methods; reporting crimes accurately by introducing real-time tracking would ultimately culminate in a fail-safe for the average person and become a crime deterrent.

### CROSS-REFERENCE TO RELATED APPLICATIONS

This application claims priority to U.S. Provisional Application No. 61/184,478, entitled “Panic Activated Locator (P.A.L.)” and filed on Jun. 5, 2009, the disclosure of which is hereby incorporated in its entirety by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

Several different scenarios culminated in the advent of the Panic Activated Locator (P.A.L.). Statistically the need for a simple, reliable, and superior emergency response system is represented by the number of crimes, accidents, and abductions that occur in modern societies.

1. Field of the Invention

The P.A.L. is for all citizens from all walks of life.

2. Description of Related Art

Not Applicable

### BRIEF SUMMARY OF THE INVENTION

The P.A.L. is a device that works in conjuction with the wearer/operator and a network, including telecommunications, 911, and GPS. In concert, the three systems work together to provide accurate mobile locations and expedient, appropriate emergency response.

### BRIEF DESCRIPTION OF THE DRAWINGS

FIG. 1 illustrates the P.A.L. device in watch format using a single P.A.L. button,

FIG. 2 illustrates the P.A.L. device in watch format depicting four P.A.L. buttons with corresponding symbols on each button so that the wearer can press witchever button corresponds to the nature of their emergency,

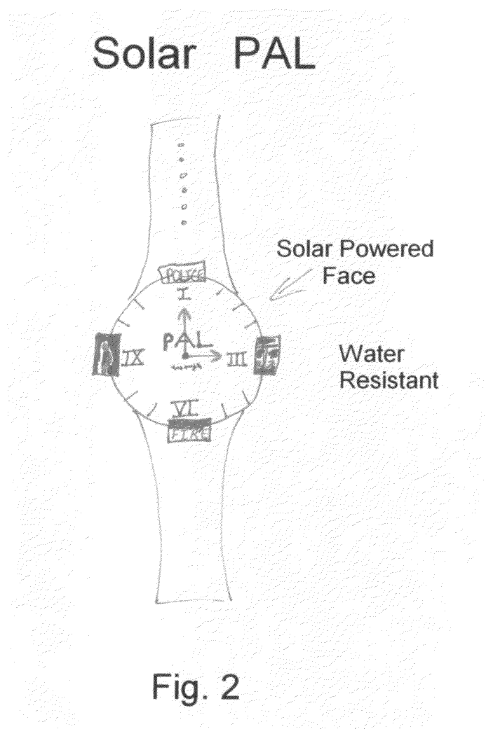

FIG. 3 illustrates the P.A.L. device in cell/mobile phone format using a single P.A.L. button

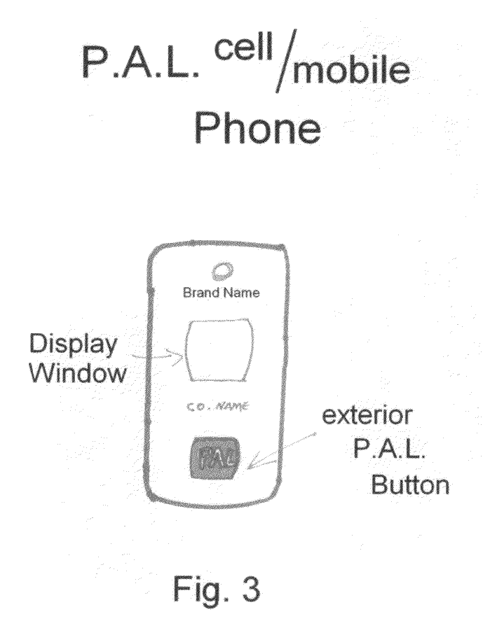

### DETAILED DESCRIPTION OF THE INVENTION

The P.A.L. is an acronym for Panic Activated Locator. The P.A.L. is a device that works in conjunction with the wearer/operator and a network such as telecommunications, satellites, police, Interpol, fire, search and rescue, emergency medical, and all branches of the military (if applicable), whereby the P.A.L. as depicted in the illustrations is worn or carried so that it is on the person at all times. In the event of any instance that may result in a panicked/emergency situation the wearer/operator simply pushes the panic button twice consecutively, or the like, within a ten second time frame. As a result a signal is sent to a satellite and the wearer is identified through a telecommunications carrier. At such time the information of the wearers phone number, address, and identity is immediately known and they are contacted by telephone/mobile phone, while simultaneously their exact location via GPS/triangulation or some such method is immediately calculated by means of a receiving unit inside the P.A.L. At which time if the person who pressed the panic button is unable to be contacted by phone; they can be simultaneously tracked in real time, the nature of their emergency is displayed, and the closest applicable response team is sent to their aid. Under catastrophic circumstances such as earthquake, fire, or flood the telecommunications carrier/network would respond accordingly based upon geographic location and type of emergency response required. The P.A.L. is also designed to eliminate time wasted searching, tracking, and locating people that have emergency situations. As a result police, military, and search and rescue will be able to execute a much swifter response. The wearer/operator of the P.A.L. will now be able to thwart potential crime by alerting police instantly that there is a crime in progress, without having to convey by phone, or any audible communication, give location, or explanation. The P.A.L. is designed to be readily available at any time. It is also designed to be used for children, adults, and seniors. Once integrated into society people will no longer have to rely on telephones, alarms, or security systems. If someone is experiencing a medical emergency, for example, and they activate their locator they don't have to be near a phone, or get near a phone. People that get lost, separated, boats at sea, airplanes, anyone, anywhere will be promptly identified and found virtually immediately. Another important role the P.A.L. will play in society, because of the nature of the P.A.L. whereas it will be overtly identified on the wearer/operator or covertly worn, the P.A.L. will allow all parents to provide their children with a safety net in the event of attempted abduction, kid-napping, or assault, even something as simple as getting lost. Women who wear the covert P.A.L. in watch form, for example, will be able to avoid assault, robbery, and rape on a much more efficient scale.

The P.A.L. will most likely be introduced to the world through existing telecommunications carriers. The P.A.L. and the service will ideally be affordable for everyone due to the gravity of its usefulness and the volume of people most likely using it.

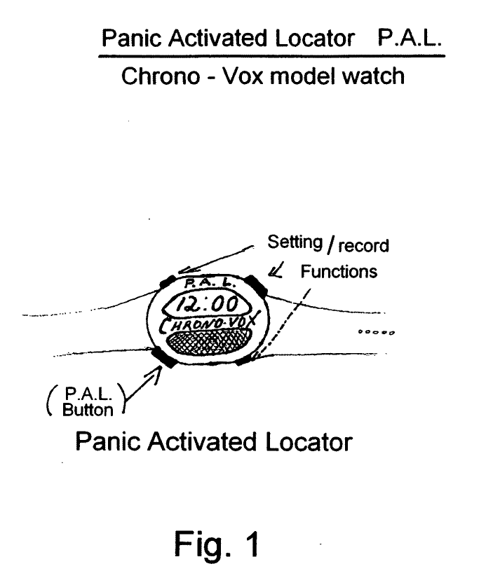

As an added feature the P.A.L. watch, as depicted in FIG. 1, is an alarm watch. The alarm is set by the wearer/operator as any typical alarm watch, and will sound in the wearer/operator's own voice in a brief recorded reminder. For example, at 3:15 the alarm sounds saying, “pick up Jimmy from school,” or more importantly for seniors to help them remember which pills to take at which time, things of that nature.

As a side note, the P.A.L. can be in any form: watch, mobile phone, compass, anything from a purse to a necklace/pendant.

Another note, as either an added feature or option, the P.A.L. PARTNER, in the case of a missing or unconscious person, can be remotely activated via a close friend or family member who will be able to send a signal to the P.A.L./P.A.L. user/wearer if P.A.L. user/wearer may be lost, unconscious or incapacitated, and by doing so will not only be able to locate them themselves, but will also remotely activate the P.A.L., which will alert the necessary rescue professionals.

What is claimed is:

1. The P.A.L. is a mobile real-time locator incorporated into a cellular phone or other device that dials 911 dispatch in panic situations at the push of a button.

2. A real-time locator as in claim 1, wherein the combination of a GPS locator and a 911 dialing device are activated by pushing a single button twice consecutively.

3. A real-time locator as in claim 2, wherein a “P.A.L.” button is located on the front, back, outside, or inside of a mobile phone, watch, or other device for easy activation.

4. A real-time locator as in claim 3, wherein upon P.A.L. activation user/wearer identification is immediately sent to 911 dispatch with the exact location of device, and real-time GPS tracking is engaged.

5. A real-time locator as in claim 4, wherein upon activation 911 dispatch attempts an immediate call back to establish the nature of the emergency, and then sends appropriate services, or nearest police if there is no response from user/wearer.

6. A real-time locator as in claim 5, wherein the P.A.L. can be remotely activated to prompt call back from 911 dispatch and locate user/wearer in scenarios of unconciousness, accident, or circumstances beyond user/wearer control.
